(19) United States
(12) Patent Application Publication
(10) Pub. No.: US 2012/0233173 A1
(43) Pub. Date: Sep. 13, 2012

(54) DETERMINING PREFERRED CATEGORIES BASED ON USER ACCESS ATTRIBUTE VALUES

(75) Inventors: Zhixiong Yang, Hangzhou (CN); Ningjun Su, Hangzhou (CN); Rongshen Long, Hangzhou (CN); Xu Zhang, Hangzhou (CN)

(73) Assignee: ALIBABA GROUP HOLDING LIMITED, George Town (KY)

(21) Appl. No.: 13/414,295

(22) Filed: Mar. 7, 2012

(30) Foreign Application Priority Data
Mar. 10, 2011 (CN) 201110058211.7

(51) Int. Cl. G06F 17/30

(52) U.S. Cl. 707/740; 707/E17.089

(57) ABSTRACT

Determining one or more preferred categories for a user is disclosed, including: determining a plurality of access attribute values corresponding to a plurality of types of access attributes associated with an access of the website by the current user; determining a plurality of categories corresponding to the plurality of access attribute values based at least in part on stored corresponding relationships between categories and access attribute values, wherein at least a portion of the determined plurality of categories comprises one or more preferred categories from which one or more products are configured to be recommended to the current user; and presenting product information associated with the one or more preferred categories.

### CROSS REFERENCE TO OTHER APPLICATIONS

This application claims priority to People's Republic of China Patent Application No. 201110058211.7 entitled PREFERRED CATEGORY DETERMINING METHOD AND DEVICE filed Mar. 10, 2011 which is incorporated herein by reference for all purposes.

### FIELD OF INVENTION

The present application involves the field of information processing technology. In particular, it involves a technique for determining (preferred product categories of users.

### BACKGROUND OF THE INVENTION

Typically, a user can browse and purchase products that are advertised at e-commerce websites. E-commerce websites sometimes feature a profile of a product with information (e.g., specifications, cost, photos) describing that product.

Some e-commerce websites will determine one or more product categories that a user seems to especially prefer among all the available product categories. Then, the e-commerce website will recommend one or more products from the preferred categories to present to the user. For example, recommended products can appear on a portion of a webpage associated with the e-commerce website that the user is currently browsing. For some e-commerce websites, the recommended products are determined based on the respective popularities of products within the preferred categories. For example, the higher the popularity of a product, the more likely that product will be recommended to the user. In one example, the popularity of a product can be determined based on the number of user operation actions (e.g., types of user operation actions include clicking actions, purchase actions, bookmarking actions) that have been performed with respect to that product within a predetermined period of time. In the example, the popularity of a product can be determined as a value that is the sum of the number of each type of user operation action.

FIG. 1 is a flow diagram showing an example of how some e-commerce websites determine a user's preferred categories of products. The example process shows that a user's preferred categories of products are determined based on the user's historical user operation action data. For example, a user's historical user operation action data includes the user's historical clicking actions, purchasing actions, and bookmarking actions, among other online interactions with respect to various products available at an e-commerce website.

At 102, a plurality of products, each of which is associated with at least one historical user operation action performed within a predetermined period, is determined. For example, a user's historical user operation action data performed within a predetermined period of time is tracked by the e-commerce website.

At 104, a plurality of categories corresponding to the plurality of products is determined. For example, the product category to which each of the plurality of products belongs is determined. For instance, a tennis racquet product will be determined to belong to the sporting goods product category.

At 106, for each of the plurality of categories, the number of each type of historical user operation action associated with the category is determined. For example, assume that the determined categories are category A and category B. Across all products in the historical user operation action data that belong to category A, the total number of clicking actions by the users in the system is determined to be 10, and the total number of bookmarking actions by the users is determined to be 5. Across all products in the historical user operation action data that belong to category B, the total number of clicking actions is determined to be 20 and total number of bookmarking actions is determined to be 12.

At 108, a weight value associated with each type of one or more types of historical user operation actions is obtained. For example, the system administrator can preset a weight value for each type of historical user operation action based on an assumed importance associated with that type of historical user operation. For example, the preset weight value for clicking actions is 1 and the preset weight value for bookmarking actions is 5.

At 110, a normalized number of historical user operation actions is determined for each of the plurality of categories based at least in part on the weight value associated with each type of historical user operation action and the number of each type of historical user operation action associated with that category. For example, the number of each type of historical user operation action associated with a category is multiplied by the corresponding obtained weight value and then the weighted numbers are summed to determine the normalized number of historical user operation actions for that category. For instance, for category A, the number of clicking actions is 10, the number of bookmarking actions is 5, the weight value for clicking actions is 1, and the weight value for bookmarking actions is 5, so the normalized number of historical user operation actions corresponding to category A is: 10×1+5×5=35.

At 112, the determined normalized numbers of historical user operation actions corresponding to the plurality of categories are used to rank the plurality of categories. For example, the categories can be ranked according to the corresponding normalized number of historical user operation actions.

At 114, a preset number of the ranked plurality of categories is selected to be preferred categories. For example, the top preset number (for example, the top N) of categories is selected to be used as the user's preferred categories when the user subsequently accesses the website.

As shown in the above process, typical techniques determine a user's preferred product categories based on the user's historical user operation actions. However, if the number of the user's historical operation actions is very small or if the user's historical operation actions are performed with respect to a random set of products (if the user frequently clicks on products that the user is not actually interested in), then the user's historical operation actions are not good indicators of the user's preferences. Additionally, for users who are accessing the website for the first time (i.e., new users of the website), no historical user operation actions exist for such users with respect to the products featured on the website and so historical user operation data cannot be used to determine the preferred categories of new users.

### BRIEF DESCRIPTION OF THE DRAWINGS

Various embodiments of the invention are disclosed in the following detailed description and the accompanying drawings.

FIG. 1 is a flow diagram showing an example of how some e-commerce websites determine a user's preferred categories of products.

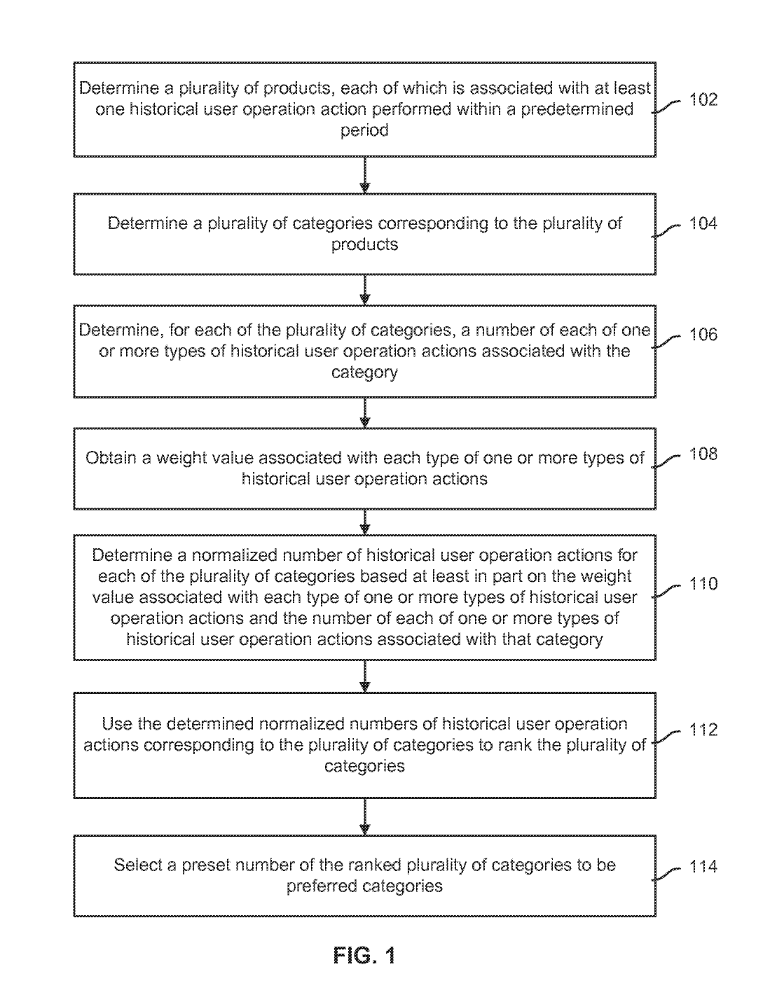

FIG. 2 is a diagram showing an embodiment of a system for determining preferred product categories using corresponding relationships between product categories and access attribute values.

FIG. 3 is a flow diagram showing an embodiment of a process of determining preferred product categories using stored corresponding relationships between product categories and access attribute values.

FIG. 4 is a flow diagram showing an embodiment of a process tier determining stored corresponding relationships between categories and access attribute values.

FIG. 5 is a flow diagram showing an embodiment of a process for determining popularity of products.

FIG. 6 is a diagram of an embodiment of software layers in a preferred categories server.

FIG. 7 is a diagram of an embodiment of a system for determining preferred product categories using corresponding relationships between product categories and access attribute values.

### DETAILED DESCRIPTION

The invention can be implemented in numerous ways, including as a process; an apparatus; a system; a composition of matter, a computer program product embodied on a computer readable storage medium; and/or a processor, such as a processor configured to execute instructions stored on and/or provided by a memory coupled to the processor, in this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining preferred product categories using corresponding relationships between product categories and access attribute values is described. In some embodiments, preferred product categories are determined using the access attribute values of a user who is currently accessing an e-commerce website. In various embodiments, access attributes are attributes that describe a user's current visit (“access”) at the website. In some embodiments, the access attributes can be preset for each access by any user and the values to the preset access attributes can be determined each time that a user visits the website. The access attributes can be chosen to describe a current geographic location of a user and/or one or more other characteristics of the user and/or of the user's particular visit to the website. In some embodiments, the user who is currently accessing the website is an existing user or anew user of the e-commerce website. In some embodiments, preferred product categories are determined using corresponding relationships between product categories and access attribute values. In some embodiments, corresponding relationships between product categories and access attribute values are predetermined and retrieved from storage. For example, the corresponding relationships between product categories and access attribute values can be based on historical patterns of correlation between each product category and the access attribute values associated with previous users that have preferred (e.g., frequently purchased or browsed) products associated with that product category. In some embodiments, one or more preferred categories are determined for the user who is currently accessing the website and then products from the one or more product categories are recommended to the user. In some embodiments, products of the one or more preferred categories are determined based at least in part on determined popularity values corresponding to the products.

Using access attributes to determine preferred categories and ultimately prod recommendations can be advantageous especially for new users of the e-commerce website because there is no historical user operation data stored for such users. For example, users of the e-commerce website can be associated with various regions around a country or even the world. Naturally, preferences of the users may vary based at least in part on the different physical regions at which the users are based. Thus, if product recommendations can be tailored to each new user using attributes related to the current access of the e-commerce website by the new user (as opposed to pushing the same predetermined set of product recommendations to all new users), then the product recommendations may at least bear some relevance to the user's current whereabouts and then appeal to the new user to the website.

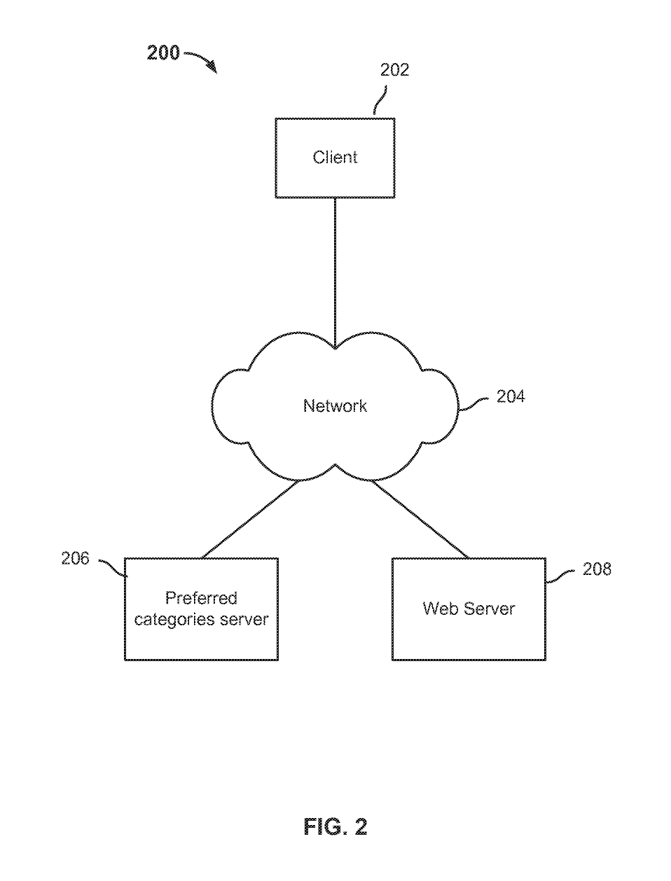

FIG. 2 is a diagram showing an embodiment of a system for determining preferred product categories using corresponding relationships between product categories and access attribute values. System 200 includes client 202, network 204, preferred categories server 206, and web server 208. Network 204 can be implemented using high-speed and/or telecommunications networks.

Client 202 can be a laptop computer, a desktop computer, a tablet, a mobile device, a smart phone, or any other computing device. In some embodiments, a web browser application is installed at each client and enables a user to access webpages associated with an e-commerce website hosted by one or both of preferred categories server 206 and web server 208. In some embodiments, preferred categories server 206 and web server 208 are part of the same device or are part of separate devices.

For a user accessing the e-commerce website by browsing at the website using a web browser at client 202, preferred categories server 206 is configured to determine one or more preferred product categories for the user based on one or more access attribute values of the user. For example, when the user accesses the website, certain attributes related to the user's visit will be stored. These attributes can reflect the time of the access (e.g., when the visit was made during the day), the user's geographical location (e.g., where the user is physically located), a type of premise with which the client device is associated (e.g., the user is accessing from an academic institution), and so forth. These attributes associated with the user for this access will be used (e.g., instead of using historical user operation data) to determine categories of products that will likely be preferred by the user based on predetermined and stored corresponding relationships between access attribute values and categories. Then, products from the preferred categories are recommended to the user by, for example, sending information regarding such products to be displayed at webpages of the e-commerce website during the user's access of the website at the client device. The concept of using the access attributes associated with a user's visit to the e-commerce website to determine preferred categories is especially advantageous in determining product recommendations for new users, for which no historical user operation data can be drawn upon to make such recommendations.

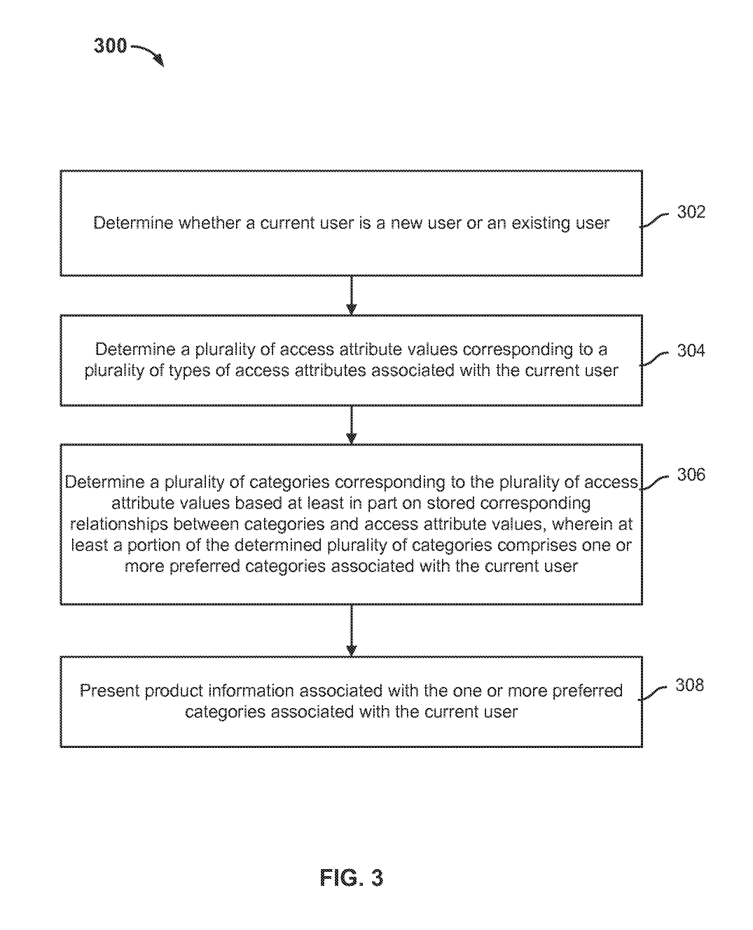

FIG. 3 is a flow diagram showing an embodiment of a process of determining (preferred product categories using stored corresponding relationships between product categories and access attribute values. In some embodiments, process 300 is implemented at system 200.

Process 300 is performed to determine, for a user who is currently accessing the e-commerce website, preferred categories at an e-commerce website. For example, the user who is currently accessing a website can be a user that is currently browsing a webpage associated with the e-commerce website. As used herein, the user that is currently accessing the website is referred to as a “current user.” One benefit of determining preferred categories is so that products associated with such categories can be recommended to the current user.

In some embodiments, process 300 is separately performed for each current user at the website. Put another way, process 300 may be performed each time a user visits the website.

At 302, the current user is determined to be either a new user or an existing user.

In some embodiments, 302 is optionally performed. In some embodiments, if the current user is determined to be an existing user of the e-commerce website, then process 300 ends because preferred categories can be determined for the existing user based on data other than access attributes (e.g., preferred categories can be determined for the existing user based on the user's historical operation actions, as described above). In some embodiments, if the current user is determined to be a new user of the e-commerce website, then process 300 proceeds because historical data such as historical user operation actions are not available for the new user and therefore cannot be used to determine preferred categories.

The following is an example of techniques used to determine whether the current user is an existing user or a new user:

If the current user accesses the e-commerce website by logging in using login information (e.g., login information such as a login identity and password), then the current user can be determined to be an existing user of the website. If the current user does not log into the website when accessing the website but the current user has previously accessed the website such as indicated by certain temporary access identifiers allocated to the current user and used by the current user to access the website (which are stored on the local device by the web browser), then the current user is also determined to be an existing user of the e-commerce website. Examples of temporary access identifiers allocated to the current user by the website are generally stored as part of cookie files or flash files or other similar types of identification files stored by the current user's web browser.

If the current user does not log into the e-commerce website and also no temporary access identifiers are stored by the web browser, then the current user is determined to be a new user of the website. New users are generally divided into two types. The first type of new users are users who are accessing the website for the first time and so have no temporary access identifiers stored by their browsers. The second type of new users are users who have previously accessed the website but have cleared the cookie files or flash files or other identification files in which temporary access identifiers are stored, and so these users also have no temporary access identifiers stored by their browsers.

In some embodiments, the current user is determined to be a new user if the user does not log into the website and does not have any temporary access identifiers stored by the web browsers. In some embodiments, the current user is determined to be an existing user if the user does log into the website and/or has temporary access identifiers stored for him/her.

At 304, a plurality of access attribute values corresponding to a plurality of types of access attributes associated with the current user is determined.

In various embodiments, each time a user (new or existing) accesses the website, the values of one or more types of access attributes associated with that access (i.e., visit by the user) will be identified and stored. In some embodiments, one access attribute value is stored for each type of access attribute. Such stored access attribute values will be the basis for determining the current user's preferred categories.

In various embodiments, the types of the current user's access attributes include at least one or more of the following: access address attribute, access location attribute, access time period attribute, and access source method attribute.

In some embodiments, the current user's access address attribute refers to the geographical location of the user at the time of website access. In some embodiments, the geographical location of the user can be determined, for example, using the internet protocol (IP) address of the access. For example, if it is determined based on the IP address of the access that the user is located in Hangzhou, then the value of the access address attribute of the current user is “Hangzhou.”

In some embodiments, the current user's access location attribute refers to the type of location where the user is accessing the website. For example, values of the access location attribute can include a school, a research institute, an internet cafe, a residential home, or a place of work. For example, a location associated with the current access can be determined based on identifying that the IP address of the user is known to be associated with a particular type of location or using one or more scripts that run on the website to collect location type information of the current user.

In some embodiments, the current user's access time period attribute refers to the time period when the user is accessing the website. In some embodiments, there can be multiple methods of defining user access time periods. For example, values of the access time periods can be defined as follows: working hours (8 am to 6 pm) and non-working hours (6 pm to 8 am); or working days (Monday through Friday) and non-working days (Saturday and Sunday); or mornings (6 am to 12 noon), afternoons (12 noon to 6 pm), and nights (6 pm to 6 am), in some embodiments, the hours are adjusted according to the local time of the user's access location.

In some embodiments, the current user's access source method attribute refers to the means by which the user is currently accessing the website. For example, values of the access source method attribute can be that the current user has accessed the e-commerce website using a search engine, the current user has accessed the e-commerce website by entering the uniform resource locator (URL) of the e-commerce website into a web browser, or the current user has accessed the e-commerce website by means of the web address information provided by a navigation website that redirected the user to the current website.

At 306, a plurality of categories corresponding to the plurality of access attribute values is determined based at least in part on stored corresponding relationships between categories and access attribute values, wherein at least a portion of the determined plurality of categories comprises one or more preferred categories associated with the current user.

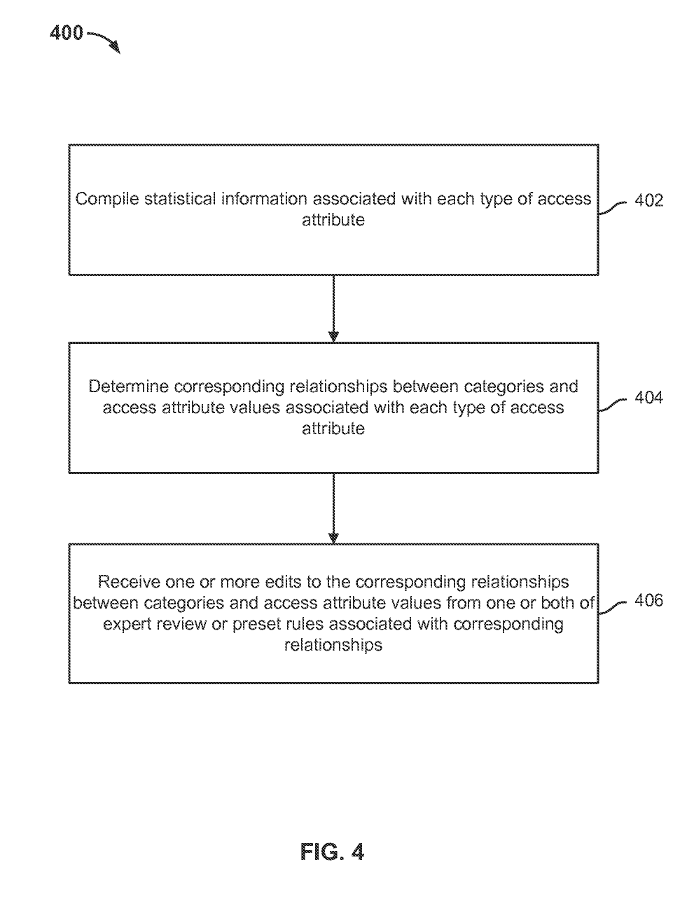

In various embodiments, for each access attribute value associated with a type of access attributes (e.g., the value of the access address attribute) that is determined for the current user, one or more categories associated with that access attribute value are determined based on predetermined or preset stored corresponding relationships between categories and access attribute values. In some embodiments, the access attribute values of the current user are searched for in the stored corresponding relationships and the categories associated with those matching access attribute values in the stored corresponding relationships are determined to be potential preferred categories of the current user. In various embodiments, the corresponding relationships between categories and access attribute values are determined prior to an implementation of process 300 and stored so that they can be retrieved and used in an implementation of process 300. FIG. 4 is a flow diagram showing an embodiment of a process for determining stored corresponding relationships between categories and access attribute values. In various embodiments, process 400 is implemented prior to a performance of process 300.

At 402, statistical information associated with each type of access attribute is compiled. For example, the corresponding relationships between categories and access attribute values can be determined based at least in part on compiling statistical information to infer a correlation between a user access attribute value and the product categories that the users associated with that user access attribute value appear to prefer historically (e.g., through frequent browsing or purchasing of products associated with those categories). User access attribute values can be determined from historical user access attribute data associated with various previous users at the e-commerce website maintained by the system. The historical user access attribute data used to compile the statistical information can be associated with a time period specified by the system administrator, for example.

At 404, corresponding relationships between categories and access attribute values associated with each type of access attribute are determined. For example, statistical information (e.g., a statistical model determined using a known technique) can be compiled for each type of access attribute and the categories associated with that type of access attributes' values. For example, statistical information can be compiled for the values of the types of access address attribute, access location attribute, access time period attribute, and access source method attribute. By analyzing the compiled statistical information using a known technique, one or more categories that appear to be preferred by previous users associated with each of the different access address attribute values, one or more categories that appear to be preferred by previous users associated with each of the different access location attribute values, one or more categories that appear to be preferred by previous users associated with each of the different access time period values, and one or more categories that appear to be preferred by previous users associated with each of the different access source method values can be determined and stored.

In some embodiments, once one or more categories preferred by users associated with an access attribute value are determined, the degree of preference of each such category by the users associated with the access attribute value is determined. For example, the degree of preference of each such category by the users associated with the access attribute value can be determined by calculating a percentage of the previous users associated with that access attribute value that prefer the category from the group of all previous users that are associated with that access attribute value. For example, if the determined categories that are preferred by the 50 total users whose access location attribute value is “school” are category A, category B, and category C, and the number of previous users that were associated with the access location attribute value of school who preferred category A is 10, the number of users that were associated with the access location attribute value of school who preferred category B is 20, and the number of users that were associated with the access location attribute value of school who preferred category C is 20, then the degree of preference of category A for access location attribute value of school is V1A=(10 out of 50 users associated with the access location attribute value of “school” that prefer category A)=0.2, the degree of preference of category B for access location attribute value of school is V1B=(20 out of 50 users associated with the access location attribute value of “school” that prefer category B)=0.4, and the degree of preference of category C for access location attribute value of school is V1C=(20 out of 50 users associated with the access location attribute value of “school” that prefer category C)=0.4.

At 406, one or more edits to the corresponding relationships between categories and access attribute values are received from one or both of expert review or preset rules associated with corresponding relationships. In some embodiments, 406 is optionally performed.

In some embodiments, the determined corresponding relationships between categories and access attribute values are edited by experts and/or preset rules. Edits received for the determined corresponding relationships between categories and access attribute values can include adding new corresponding relationships or removing some corresponding relationships.

For example, the determined corresponding relationships between categories and access attribute values are submitted to an expert to perform one or more edits. Experts can be individuals with specialized knowledge in determining preference of product categories of users associated with certain access attribute values. For example, an expert can determine that ceramic goods from Quanzhou, Fujian have been historically favored and purchased by online shoppers located in the local area more so than online shoppers from any other area. So the expert can create a corresponding relationship between the product category of “ceramic goods” with the access address attribute value of “Quanzhou, Fujian.”

For example, a preset rule could be the following: one or more of the determined corresponding relationships between categories and access attribute values can be removed if a degree of preference of users associated with a particular attribute access value for a category is below a set degree of a preference threshold. The rationale for removing a corresponding relationship is that if only a very small proportion of users associated with a particular attribute access value seems to prefer a particular category, then the correlation between that attribute access value may not be high enough to be used for the purposes of recommending products to users.

The following table, Table 1, is an example including some of the determined corresponding relationships between categories and access attribute values, In Table 1, the left most column includes various types of access attributes, the second to the left column includes one or more access attribute values corresponding to each type of access attribute, the third column from the left includes the categories preferred by users associated with the corresponding access attribute values of the same row, and the fourth column from the left includes the determined degree of preference by users associated each access attribute value for each of the categories preferred by users associated with that access attribute value.

TABLE 1

| Access Attribute | Attribute Access | | Degree of |
|---|---|---|---|
| Type | Values | Categories | Preference |
| Access address | Access address San | Category A | V1A |
| attribute | Francisco, California | Category B | V1B |
| | Access address Los | Category C | V2C |
| | Angeles, California | | |
| Access location | Access location | Category D | V3D |
| attribute | research institute | | |
| | Access location | Category E | V4E |
| | school | Category F | V4F |
| Access time period | Access time period | Category G | V5G |
| attribute | working hours | | |
| Access source | Access source search | Category H | V6H |
| method attribute | engine | Category I | V6I |
| | Access source | Category J | V7J |
| | navigation site | | |

For example, given the stored corresponding relationships between categories and access attribute values shown in Table 1, if the current user was associated with the following access attribute values of access address San Francisco, Calif.; access location school; access time period working hours; and access source search engine, then the following categories would be determined using Table 1 as potential preferred categories of the current user: categories A, B, E, F, G, H, and I.

In some embodiments, each one of the potential preferred categories determined by comparing the access attribute values of the current user to the stored corresponding relationships is determined to be a preferred category of the current user.

In some embodiments, only those potential preferred categories that are associated with a general degree of preference above a preset threshold value are determined to be preferred categories of the current user or only those potential preferred categories that are associated with a general degree of preference that is among the top X number of potential preferred categories ranked by their respective general degrees of preferences are preferred categories of the current user. In some embodiments, the general degree of preference of each potential preferred category is determined as follows:

For example, for a potential preferred category, the degree of preference between that potential preferred category and each access attribute value with which the potential preferred category is associated is determined from the stored corresponding relationships. Then, the degree of preference associated with the potential preferred category and each of the access attribute values with which it had a stored corresponding relationship is combined together to determine the general degree of preference for the potential preferred category, For instance, assume that category A is a category associated with both access attribute value 1 and access attribute value 2 in the stored corresponding relationships. In this example, the degree of preference of category A for access attribute value 1 is V1A, and the degree of preference of category A for access attribute value 2 is V2A, then the general degree of preference for category A is VA=V1A+V2A. In some embodiments, a weight value (e.g., an integer value) may be set in advance and stored (e.g., by a system administrator) for each type of access attribute so that in determining the general degree of preference of a category, each degree of preference for an access attribute value associated with the category is multiplied by the weight value (e.g., that is retrieved from storage) corresponding to the associated type of access attribute and then all of the weighted degrees of preference for the category are summed to determine the general degree of preference for that category.

Example preset weight values associated with the types of access attributes are shown in Table 2, where W1, W2, W3, and W4 each represents an integer value greater than zero:

TABLE 2

| Access Attributes Type | Weight value |
|---|---|
| Access address attribute | W1 |
| Access location attribute | W2 |
| Access time period attribute | W3 |
| Access source method attribute | W4 |

Referring to the example of Table 2, Category A is a potential preferred category for access attribute value 1 and access attribute value 2, where access attribute value 1 is the access attribute value for the access address attribute, and access attribute value 2 is the access attribute value for the access time period attribute. The degree of preference of category A for access attribute value 1 is V1A, and the degree of preference of category A for access attribute value 2 is V2A. Given that the weight value of the access address attribute is W1 and the weight value of the access time period attribute is W3, the weighted degree of preference of category A for access attribute value 1 is V′1A=V1A×W1 and the weighted degree of preference of category A for access attribute value 2 is V′2A=V2A×W3, and so the general degree of preference of category A is VA=V′1A+V′2A.

Referring back to FIG. 3, at 308, product information associated with the one or more preferred categories associated with the current user is presented.

Once one or more preferred categories are determined for the current user, information regarding one or more products associated the preferred categories can be recommended to the current user by way of being presented to the current user. For example, featured products associated with the preferred categories can be displayed at webpages associated with the e-commerce website that the user is currently browsing. For instance, if sporting goods were determined as a preferred category, then a product from the sporting goods category such as a Prince® EXO3 Tour 100 tennis racquet could be featured as a recommended product for the current user. An image of the Prince® EXO3 Tour 100 tennis racquet can be displayed at a “Recommended products” section of a webpage that the current user is browsing and in the event that the user selects the image, he or she will be directed to a product profile page for the Prince® EXO3 Tour 100 tennis racquet that includes information about the product such as price, specifications, and so forth.

In some embodiments, products from the preferred categories are selected to be recommended to the current user based on how popular the products are. In some embodiments, the popularity of each product is determined prior to determining which products to recommend. For example, for each preferred category, products in that category are ranked based on their respectively determined popularities and the top Y (e.g., where Y is an integer value configured by a system administrator) most popular products in that category are recommended to users for which that category is determined to be a preferred category. For example, the popularity of a product can be determined using a process such as process 500 as described below.

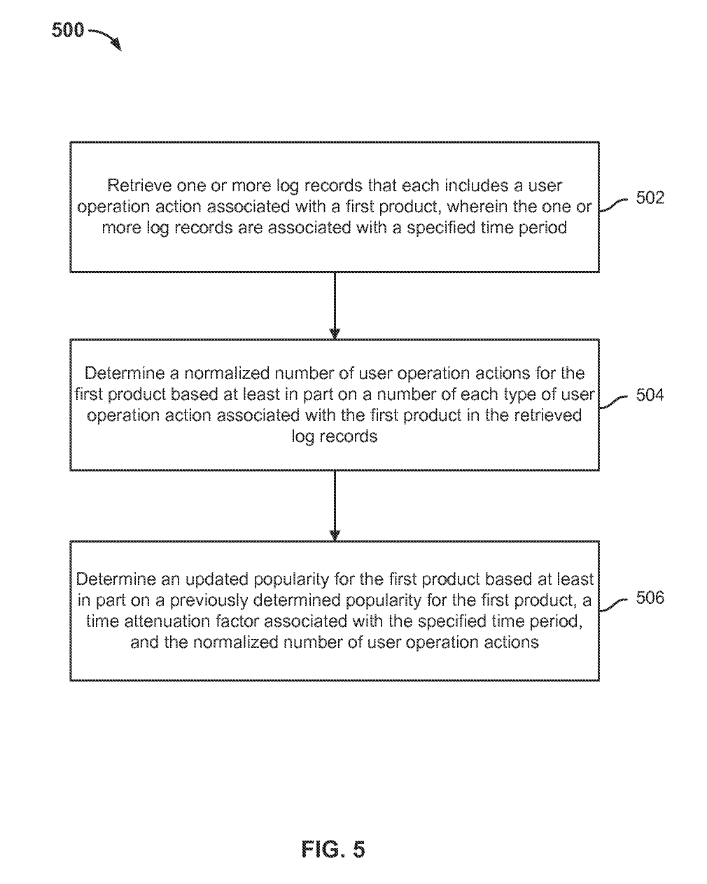

FIG. 5 is a flow diagram showing an embodiment of a process for determining popularity of products. In some embodiments, process 500 is implemented at system 200. In various embodiments, the popularity of a product refers to a value, where the magnitude of the value correlates with how popular the product is among users at the e-commerce website.

At 502, one or more log records that each includes a user operation action associated with a first product are retrieved, wherein the one or more log records are associated with a specified time period.

Anytime a user accesses the e-commerce website, the user may perform one or more user operation actions such as, for example, clicking actions, comment posting actions, clicking seller contact information actions, bookmarking actions, order placement actions, payment actions, and refund actions with respect to one or more products available at the website. For each of a user's visits to the e-commerce website, the web browser can collect and store information in the form of a log record that indicates one or more of the following pieces of information: a particular user operation action that was performed with respect to a particular product, a timestamp associated with the visit, and an identifier associated with the user. Table 3 below shows an example of a table that includes the information stored for a log record associated with a user's particular visit to the e-commerce website. In the example of Table 3, the user performed a clicking action and a comment posting action with respect to Product A, the user performed a clicking seller contact information action, a bookmarking action, and an order placement action with respect to Product B, the user performed a payment action with respect to Product C, and the user performed a refund action with respect to Product D during that visit.

TABLE 3

| Products | User operation actions |
|---|---|
| Product A | Clicking action |
| | Comment posting action |
| Product B | Clicking seller contact information |
| | action |
| | Bookmarking action |
| | Order placement action |
| Product C | Payment action |
| Product D | Refund action |

In some embodiments, log records can be analyzed on a periodic basis to determine/update popularities of products. For example, a time period can be specified (e.g., specified by a system administrator) for which tog records associated with that time period will be retrieved and used to analyze the popularity of various products associated with those log records. An example time period can be one month. In some embodiments, the popularity of products can be determined based on only a portion of the retrieved log records.

At 504, a normalized number of user operation actions is determined for the first product based at least in part on a number of each type of user operation action associated with the first product in the retrieved tog records.

In various embodiments, a normalized number of user operation actions is determined for each product mentioned in the retrieved log records. To determine the normalized number of user operation actions for a product, the log records that include user operation action data associated with that product are programmatically analyzed to determine a number of each type of user operation action (e.g., the number clicking actions associated with that product, the number of comment posting actions associated with that product . . . etc). Then the determined number of each type of user operation action is multiplied by a weight value assigned (e.g., by a system administrator) to that type of user operation action to determine ermine the weighted number of each type of operation action.

Table 4 below shows an example of a table that includes weight values assigned to different types of user operation actions.

TABLE 4

| User operation Action | Action Weighting |
|---|---|
| Clicking action | 1 |
| Comment posting action | 3 |
| Clicking seller contact information action | 2 |
| Bookmarking action | 5 |
| Order placement action | 10 |
| Payment action | 5 |
| Refund action | −12 |

Once the weighted number is determined for each type of user operation action (e.g., clicking action, comment posting action, clicking seller contact information action, bookmarking action, order placement action, payment action, and refund action), the weighted numbers corresponding to all types of user operation actions are added together to determine the normalized number of user operation actions for the product. For example, with respect to product A, the number of clicking actions is 10, the number of bookmarking actions is 5, the number of order placement actions is 3, and the number of refund actions is 1, thus the normalized number of operation actions for product A within the specified time period is 10×1+5×5+1×10−1×12=51.

At 506, an updated popularity is determined for the first product based at least in part on a previously determined popularity for the first product, a time attenuation factor associated with the specified time period, and the normalized number of user operation actions.

Process 500 includes a time attenuation factor to attenuate a previously determined popularity (e.g., a popularity value determined from a previous time period) for a product so that the attenuated previously determined popularity can be used to update the popularity of the product determined for the currently specified time period. Taking the previously determined popularity into account in determining a current popularity can reflect the effect of the popularity from a time period that was immediately before the current time period for which the current popularity is being determined. Thus, while the current popularity of a product incorporates the popularity previously deter for the product, the effect of the previously determined popularity has a lessened effect on the current popularity (due to the attenuation) than the most recent data associated with the product.

In various embodiments, a basic time attenuation factor is configured in advance (e.g., by a system administrator) based on observed patterns of product popularity attenuation over time for any product in general or for a particular product. In some embodiments, the basic time attenuation factor expresses the amount of attenuation of a product's popularity in 1 day. Assume that the basic time attenuation factor is represented by a. If the popularity of a product takes 60 days to attenuate from 1 to 0.01, then it is understood that a⁶⁰=0.01, and the basic time attenuation factor is 0.9261. If the popularity of a product takes in days to attenuate from 1.0 to 0.01, then it is understood that a^{m}=0.01, from which the basic time attenuation factor can be computed. Based on the configured basic time attenuation factor, the time attenuation factor associated with the specified time period can be determined. If the specified time period is n days, then the time attenuation factor corresponding to the specified time period is aⁿ.

The following formula is one example of determining the updated popularity (f) of the product for the specified time period:

f=f2+f1×aⁿ

where the popularity of a product within the specified time period is f, the normalized number of user operation actions within the specified time period is f2, the previously determined product popularity is f1, the specified time period encompasses n days, and the time attenuation factor is aⁿ (where f1×aⁿ is the time-attenuated popularity corresponding to the previously determined product popularity).

When popularity is determined for a product for the first time, after obtaining the log records within a specified time period, a product popularity initialization operation may be performed. For example, in the product popularity initialization operation, the user operation action records for the user within the specified time period are extracted from the log records, and the specified time period is divided into several sub-periods, for example, where each sub-period corresponds to one day. For each sub-period, the number of each type of user operation actions within the sub-period is multiplied by the assigned weight value corresponding to that type of user operation action to determine obtained weighted numbers of user operation actions within the sub-period. The weighted numbers are summed together and the sum is multiplied by a time attenuation factor corresponding to that sub-period to obtain the normalized number of operation actions for the product within that sub-period, which is taken as the initialized product popularity corresponding to the product.

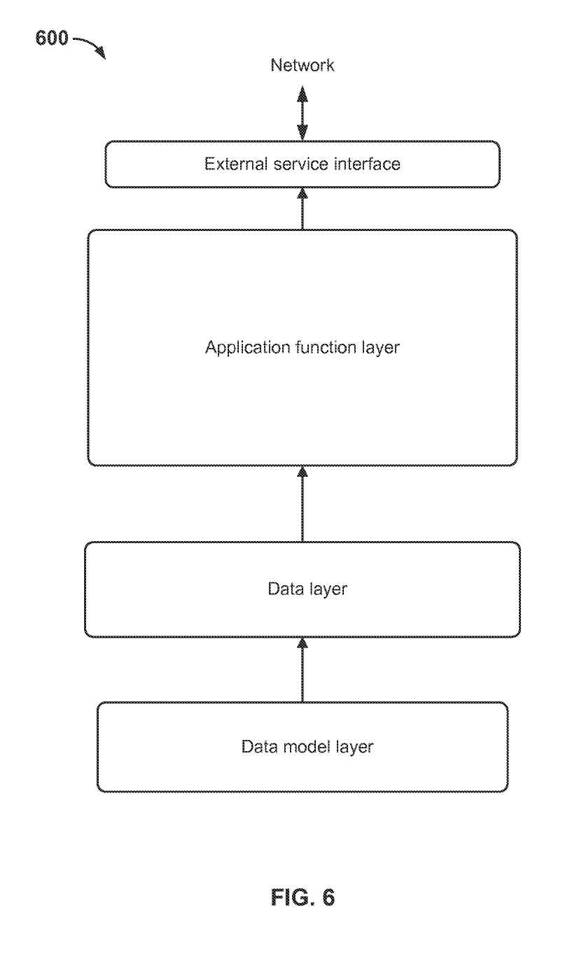

FIG. 6 is a diagram of an embodiment of software layers in a preferred categories server. In some embodiments, software layers 600 are implemented at a preferred categories server such as preferred categories server 206. In various embodiments, each layer in software layers 600 is implemented using software. In the example, software layers 600 include a data model layer, a data layer, an application function layer, and an external service interface. The external service interface receives and sends data from over a network (e.g., the Internet). For example, the external service interface receives an indication associated with a user accessing the e-commerce website from a remote client device. The application function layer determines whether this current user is a new user or an existing user of the e-commerce website, one or more preferred categories for the current user, and one or more recommended products from the preferred categories for the current user using a process such as process 300. The recommended products and/or information thereof are sent to the remote client device via the external service interface. The data layer determines and stores corresponding relationships between categories and access attribute values using a process such as process 400. The data layer determines products from each of various categories to recommend to a user once certain categories are determined as preferred categories of the user. In some embodiments, the data layer could supply the determined corresponding relationships between categories and access attribute values and products to recommend from various categories to the application function layer so that the application function layer could perform process 300. The data model layer determines the popularity of each of various products using a process such as process 500. In some embodiments, the data model layer also compiles statistical information to be used by the data layer in implementing process 400 to determine corresponding relationships between categories and access attribute values. In some embodiments, the data model layer supplies the determined popularities of products and the compiled statistical information to the application function layer and the data layer so that the other layers can implement processes 300 and 400.

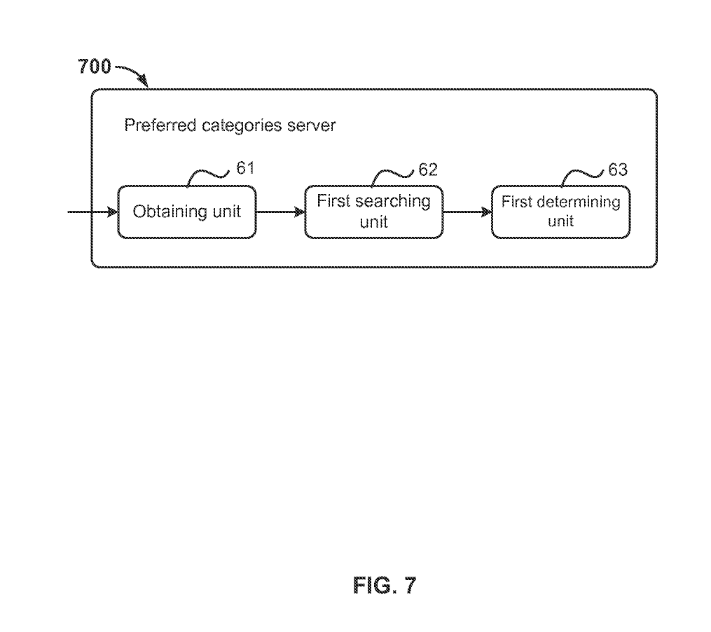

FIG. 7 is a diagram of an embodiment of a system for determining preferred product categories using corresponding relationships between product categories and access attribute values. In some embodiments, preferred categories server 206 is implemented using system 700.

The units, sub-units, modules, and sub-modules can be implemented as software components executing on one or more processors, as hardware such as programmable logic devices and/or Application Specific Integrated Circuits designed to perform certain functions, or a combination thereof. In some embodiments, the units, sub-units, modules, and sub-modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units, sub-units, modules, and sub-modules may be implemented on a single device or distributed across multiple devices.

In the example, system 700 includes obtaining unit 61, first searching unit 62, and first determining unit 63.

Obtaining unit 61 is configured to obtain the access attribute values corresponding to various types of access attributes for the user currently accessing the e-commerce website.

First searching unit 62 is configured to determine one or more potential preferred categories for the access attribute values obtained for the current user based on stored corresponding relationships between access attribute values and categories.

First determining unit 63 is configured to determine the current user's preferred categories based on the potential preferred categories found by first searching unit 62.

In some embodiments, system 700 further includes a second determining unit and a third determining unit (not shown). The second determining unit is configured to determine whether a current user is a new user at the e-commerce website or an existing user of the e-commerce website. In some embodiments, the second determining unit determines whether the current user has logged into the e-commerce website. The third determining unit is configured to determine whether there are any local files (e.g., cookies) stored at the web browser of the current user that are associated with the e-commerce website.

In some embodiments, first determining unit 63 includes a first determining sub-unit, a first selection sub-unit, and a second determining sub-unit (not shown). The first determining sub-unit is configured to determine the general degree of preference for each potential preferred category found by first searching unit 62. The first selection sub-unit is configured to select the potential preferred categories having general degrees of preference that satisfy a preset condition. The second determining sub-unit is configured to determine the preferred categories selected by the first selection sub-unit to be the current user's preferred categories.

In some embodiments, the first determining sub-unit includes a first determining module and a second determining module. The first determining module is configured to determine the degree of preference for each access attribute value in the stored corresponding relationships between access attribute values and the categories. The second determining module is configured to determine the general degree of preference of each preferred category found by first searching unit 62 based on the degree of preference of each access attribute value associated with that category.

In some embodiments, the second determining module includes an obtaining sub-module, a first determining sub-module, and a second determining sub-module. The obtaining sub-module is configured to obtain the weight values assigned to the different types of access attributes. The first determining sub-module is configured to determine for each access attribute value corresponding to each preferred category found by first searching unit 62 the weighted degree of preference by multiplying the appropriate weight value by the degree of preference. The second determining sub-module is configured to determine the sum of the weighted degrees of preference of each of the preferred categories found by first searching unit 62 to be the general degree of preference of the preferred category.

In some embodiments, system 700 further includes a first providing unit (not shown) configured to provide the preferred category information determined by the first determining unit 63 to the current user.

In some embodiments, system 700 further includes a fourth determining unit (not shown), a second searching unit, and a second providing unit. The fourth determining unit is configured to determine which products belong to which product categories. The second searching unit is configured to determine products to recommend from the one or more preferred categories of the current user. The second providing unit is configured to present the product information for the recommended products to the user.

In some embodiments, the fourth determining unit includes a first obtaining sub-unit, a third determining sub-unit, a fourth determining sub-unit, a second obtaining sub-unit, a fifth determining sub-unit, a sixth determining sub-unit, a second selection sub-unit, and a seventh determining sub-unit. The first obtaining sub-unit is configured to obtain log records within the specified time period, where the log records include user operation actions associated with products. The third determining sub-unit is configured to determine the number of each type of user operation actions for each product based on the obtained log records. The fourth determining sub-unit is configured to determine the normalized number of operation actions thr each product based on the number of each type of user operation actions for that product. The second obtaining sub-unit is configured to obtain the popularity previously determined for each product, as well as the time attenuation factor corresponding to the specified time period. The fifth determining sub-unit is configured to determine the time-attenuated popularity of the previously determined based on the previously determined popularity and the time attenuation factor. The sixth determining sub-unit is configured to determine the sum of the normalized numbers of operation actions for each product within the specified time period determined by the fourth determining sub-unit and the time-attenuated popularity determined by the fifth determining sub-unit to be the current popularity of the product associated with the specified time period. The second selection sub-unit is configured to select products for which the associated popularity satisfies a preset condition from among the products that belong to each category. The seventh determining sub-unit is configured to determine the products selected by the second selection sub-unit to be the recommended products of each category.

A person skilled in the art should understand that the embodiments of the present application can be provided as methods, devices (equipment), or computer software products. Therefore, the present application can take the form of embodiments comprising entirely of hardware, embodiments comprising entirely of software, and embodiments which combine software and hardware. In addition, the present application can take the form of computer programs implemented on one or more computer-operable storage media chiding but not limited to magnetic disk storage devices, CD-ROMs, and optical storage devices) containing computer program codes.

The present application is described with reference to flow charts and/or block diagrams based on methods, devices (equipment), and computer program products. It should be understood that each process and/or block in the flow charts and/or block diagrams, and combinations of processes and/or blocks in the flow charts and/or block diagrams, can be achieved through computer program commands. These computer program commands can be provided to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially operating computer-readable storage devices that can guide computers or other programmable data equipment, with the result that the commands stored on these computer-readable devices give rise to products that include command devices. These command devices realize the functions designated in one or more processes in a flow chart and/or one or more blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application. Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative, ways of implementing the invention. The disclosed embodiments are illustrative and not restrictive.

What is claimed is:

1. A method for determining one or more preferred categories for a current user at a website, comprising:
determining, using one or more processors, a plurality of access attribute values corresponding to a plurality of types of access attributes associated with an access of the website by the current user;
determining a plurality of categories corresponding to the plurality of access attribute values based at least in part on stored corresponding relationships between categories and access attribute values, wherein at least a portion of the determined plurality of categories comprises one or more preferred categories from which one or more products are configured to be recommended to the current user; and
presenting product information associated with the one or more preferred categories.

2. The method of claim 1, further comprising determining whether the current user comprises a new user or an existing user of the website.

3. The method of claim 1, wherein the product information includes recommendations associated with one or more products belonging to the preferred categories.

4. The method of claim 3, wherein the one or more products are selected to be recommended based on an updated popularity value determined for each of the one or more products.

5. The method of claim 4, wherein a determination of an updated popularity value for a first product of the one or more products belonging to the preferred categories includes:
retrieving one or more log records that each includes a user operation action associated with the first product, wherein the one or more tog records are associated with a specified time period;
determining a normalized number of user operation actions based at least in part on a number of each type of user operation action associated with the first product in the retrieved log records; and
determining the updated popularity value for the first product based at least in part on a previously determined popularity value for the first product, a time attenuation factor associated with the specified time period, and the normalized number of user operation actions.

6. The method of claim 5, wherein the updated popularity value for the first product is the sum of the product of the previously determined popularity value and the time attenuation factor and the normalized number of user operation actions.

7. The method of claim 1, wherein the corresponding relationships between categories and access attribute values are determined based at least in part on:
compiling statistical information associated with each type of access attribute based on access data associated with previous users;
determining the corresponding relationships between categories and access attribute values associated with each type of access attribute based on the access data associated with previous users; and
receiving one or more edits to the corresponding relationships between categories and access attribute values from one or both of expert review or preset rules associated with corresponding relationships.

8. The method of claim 1, wherein the plurality of types of access attributes includes one or more of: access address attribute, access location attribute, access time period attribute, and access source method attribute.

9. The method of claim 1, wherein each of the determined plurality of categories comprises a preferred category.

10. The method of claim 1, wherein those of the determined plurality of categories each associated with a general degree of preference above a preset threshold value comprises a preferred category.

11. The method of claim 1, wherein those of the determined plurality of categories each associated with a general degree of preference ranked among a top preset number of general degree of preferences respective to other categories of the determined plurality of categories comprise preferred categories.

12. A system for determining one or more preferred categories for a current user at a website, comprising:
a communication interface configured to send and receive data over a network;
a processor configured to:
determine a plurality of access attribute values corresponding to a plurality of types of access attributes associated with an access of the website by the current user;
determine a plurality of categories corresponding to the plurality of access attribute values based at least in part on stored corresponding relationships between categories and access attribute values, wherein at least a portion of the determined plurality of categories comprises one or more preferred categories from which one or more products are configured to be recommended to the current user; and
present product information associated with the one or more preferred categories; and
a memory coupled to the processor and configured to provide the processor with instructions.

13. The system of claim 12, wherein the product information includes recommendations associated with one or more products belonging to the preferred categories.

14. The system of claim 13, wherein the one or more products are selected to be recommended based on an updated popularity value determined for each of the one or more products.

15. The system of claim 14, wherein a determination of an updated popularity value for a first product of the one or more products belonging to the preferred categories includes:
retrieving one or more log records that each includes a user operation action associated with the first product, wherein the one or more tog records are associated with a specified time period;
determining a normalized number of user operation actions based at least in part on a number of each type of user operation action associated with the first product in the retrieved log records; and
determining the updated popularity value for the first product based at least in part on a previously determined popularity value for the first product, a time attenuation factor associated with the specified time period, and the normalized number of user operation actions.

16. The system of claim 15, wherein the updated popularity value for the first product is the sum of the product of the previously determined popularity value and the time attenuation factor and the normalized number of user operation actions.

17. The system of claim 12, wherein the plurality of types of access attributes includes one or more of the following: access address attribute, access location attribute, access time period attribute, and access source method attribute.

18. The system of claim 12, wherein each of the determined plurality of categories comprises a preferred category.

19. The system of claim 12, wherein those of the determined plurality of categories each associated with a general degree of preference above a preset threshold value comprises a preferred category.

20. The system of claim 12, wherein those of the determined plurality of categories each associated with a general degree of preference ranked among a top preset number of general degree of preferences respective to other categories of the determined plurality of categories comprise preferred categories.

21. A computer program product for determining one or more preferred categories for a current user at a website, the computer program product being embodied in a non-transitory computer readable medium and comprising computer instructions for:
determining a plurality of access attribute values corresponding to a plurality of types of access attributes associated with an access of the website by the current user;
determining a plurality of categories corresponding to the plurality of access attribute values based at least in part on stored corresponding relationships between categories and access attribute values, wherein at least a portion of the determined plurality of categories comprises one or more preferred categories from which one or more products are configured to be recommended to the current user; and
presenting product information associated with the one or more preferred categories.
